(19) United States
(12) Patent Application Publication
(10) Pub. No.: US 2025/0278299 A1
(43) Pub. Date: Sep. 4, 2025

(54) PROCESSOR SCHEDULING METHOD AND APPARATUS, COMPUTER DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventors: Fuhai WANG, Shenzhen (CN); Shi LIU, Shenzhen (CN); Jia WANG, Shenzhen (CN); Shouye LIU, Shenzhen (CN)

(73) Assignee: TENCENT TECHNOLOGY (SHENZHEN) COMPANY LIMITED, Shenzhen (CN)

(21) Appl. No.: 19/213,146

(22) Filed: May 20, 2025

Related U.S. Application Data
(63) Continuation of application No. PCT/CN2024/081305, filed on Mar. 13, 2024.

(30) Foreign Application Priority Data
May 9, 2023 (CN) 202310517687.5

(51) Int. Cl. G06F 9/48; G06F 1/3296

(52) U.S. Cl. CPC G06F 9/4893; G06F 1/3296; G06F 9/4825

(57) ABSTRACT

An apparatus, computer-readable memory storing a program, and method providing processor scheduling including acquiring a total load of N processors, N being a first positive integer greater than or equal to 2; generating, based on the total load, a processor bitmap distinguishing at least one active processor and at least one idle processor among the N processors; processing, based on the processor bitmap, a to-be-processed task on the at least one active processor, and adjusting, based on the processor bitmap, the at least one idle processor to a target power-saving mode.

### CROSS-REFERENCE TO RELATED APPLICATIONS

This application is a continuation application of International Application No. PCT/CN2024/081305 filed on Mar. 13, 2024 which claims priority to the Chinese Patent Application No. 202310517687.5, filed with the China National Intellectual Property Administration on May 9, 2023, the disclosures of each being incorporated by reference herein in their entireties.

### FIELD

The disclosure relates to computer power-saving technologies, and to a processor scheduling method and apparatus, a computer device, a computer-readable storage medium, and a computer program product.

### BACKGROUND

During operation, a computer device may consume certain energy, such as electrical power. To achieve power saving, some power-saving technologies may be applied to a central processing unit (CPU), enabling the CPU to operate in a power-saving mode, thereby reducing the power consumption of the computer device. However, in the related art, implementing power-saving measures for the computer device may adversely affect its operating performance.

### SUMMARY

Provided are a processor scheduling method and apparatus, a device, a storage medium, and a program product, which facilitate efficient power management in multi-processor systems by implementing processor bitmap mechanisms and adaptive power state adjustments. These embodiments enable improved system performance, power efficiency, and computational resource utilization in computing environments.

Some embodiments provide a processor scheduling method, performed by a computer device, the method comprising: acquiring a total load of N processors, N being a first positive integer greater than or equal to 2; generating, based on the total load, a processor bitmap distinguishing at least one active processor and at least one idle processor among the N processors; processing, based on the processor bitmap, a to-be-processed task on the at least one active processor; and adjusting, based on the processor bitmap, the at least one idle processor to a target power-saving mode.

Some embodiments provide a processor scheduling apparatus, comprising: at least one memory configured to store computer program code; and at least one processor configured to read the program code and operate as instructed by the program code, the program code comprising: acquiring code configured to cause at least one of the at least one processor to acquire a total load of N processors, N being a first positive integer greater than or equal to 2; generating code configured to cause at least one of the at least one processor to generate, based on the total load, a processor bitmap distinguishing at least one active processor and at least one idle processor among the N processors; processing code configured to cause at least one of the at least one processor to process, based on the processor bitmap, a to-be-processed task on the at least one active processor; and adjusting code configured to cause at least one of the at least one processor to adjust, based on the processor bitmap, the at least one idle processor to a target power-saving mode.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of skill in the art may still derive other drawings from these accompanying drawings without creative efforts. In addition, one of skill would understand that aspects of some embodiments may be combined together or implemented alone.

FIG. 1 is a schematic diagram of a CPU power-saving technology.

FIG. 2 is a schematic framework diagram of some embodiments of a CPU power-saving technology.

FIG. 3 is a schematic diagram of a relationship between different power-saving technologies.

FIG. 4 is a schematic diagram of some embodiments of a Cstate technology.

FIG. 5 is a schematic diagram of some embodiments of a Pstate technology.

FIG. 6 is a schematic framework diagram of a Turbo Boost technology.

FIG. 7 is a schematic architectural diagram of a processor scheduling system according to some embodiments.

FIG. 8 is a schematic structural diagram of a server in FIG. 7 according to some embodiments.

FIG. 9 is a schematic flow diagram I of a processor scheduling method according to some embodiments.

FIG. 10 is a schematic flow diagram II of a processor scheduling method according to some embodiments.

FIG. 11 is a schematic flow diagram III of a processor scheduling method according to some embodiments.

FIG. 12 is a schematic diagram of a server scheduling framework for a CPU according to some embodiments.

FIG. 13A is a schematic diagram of a calculation process of an active CPU bitmap according to some embodiments.

FIG. 13B is a schematic diagram of a process for selecting a CPU according to some embodiments.

FIG. 14 is a schematic comparison diagram of task scheduling based on load balancing and task scheduling based on an active CPU bitmap according to some embodiments.

FIG. 15 is a comparison diagram of limiting a sleep depth of an idle core according to some embodiments.

FIG. 16 is a schematic diagram of a variation of a maximum frequency during Turbo Boost according to some embodiments.

FIG. 17 is a schematic comparison diagram of an interrupt constraint according to some embodiments.

FIG. 18 is a schematic diagram of an interrupt migration process according to some embodiments.

FIG. 19 is a schematic diagram of an interrupt processing procedure according to some embodiments.

FIG. 20 is a schematic comparison diagram of queries per second at 128 concurrency for a 1 G data set according to some embodiments.

FIG. 21 is a schematic comparison diagram of queries per second at 128 concurrency for a 10 G data set according to some embodiments.

FIG. 22 is a schematic comparison diagram of queries per second at 128 concurrency for a 100 G data set according to some embodiments.

FIG. 23 is a schematic comparison diagram of power consumption at 128 concurrency for a 1 G data set according to some embodiments.

FIG. 24 is a schematic comparison diagram of power consumption at 128 concurrency for a 10 G data set according to some embodiments.

FIG. 25 is a schematic comparison diagram of power consumption at 128 concurrency for a 100 G data set according to some embodiments.

### DESCRIPTION OF EMBODIMENTS

To make the objects, technical solutions, and advantages clearer, the following describes this application in further detail with reference to the drawings. The described embodiments are not to be considered as a limitation to this application. All other embodiments obtained by a person of skill in the art without creative efforts shall fall within the protection scope.

In the following description, the term “some embodiments” describes subsets of all possible embodiments, but “some embodiments” may be the same subset or different subsets of all the possible embodiments, and may be combined without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In the following description, the term “first/second” is used merely to distinguish similar objects and does not indicate a specific order of an object. The “first/second” may be interchanged in terms of a specific order or sequence, where permitted, so that some embodiments described herein may be implemented in a sequence other than the one illustrated or described herein.

Unless otherwise defined, meanings of all technical and scientific terms used herein are the same as those usually understood by a person skilled in the art to which this application belongs. The terms used herein are merely intended to describe some embodiments, but are not intended to limit this application.

Before providing a more detailed description of some embodiments, the nouns and terms involved in some embodiments are explained. The nouns and terms involved in some embodiments are subject to the following interpretations.
(1) A CPU is the core of operation and control in a computer device, and serves as the final execution unit for information processing and program execution.
(2) A processor core, also known as a CPU core, is the most important component of the CPU. All calculations, command acceptance/storage, and data processing of the CPU are performed by the processor core. The components of the processor within the core are responsible for executing CPU commands, including an arithmetic logic unit (ALU), a floating point unit (FPU), level 1 cache (L1 Cache), and level 2 cache (L2 Cache).
(3) A processor uncore is a part of the CPU excluding the processor core. The functions of the uncore include a quick path interconnect (QPI) controller, a level 3 cache (L3 Cache), a snoop agent pipeline, a storage controller, and the like.
(4) Simultaneous multithreading (SMT) technology refers to executing a plurality of threads simultaneously on one core, allowing the plurality of threads to share resources of the same core.
(5) A thread is the smallest unit of execution that an operating system can schedule.
(6) Load refers to the statistical information of threads that are in a running state or a runnable state within a given period of time.
(7) Turbo Boost is a technology that automatically and intelligently adjusts the CPU frequency according to actual operating conditions after a program starts, enhancing performance while ensuring that the CPU continues to operate within predefined limits of power consumption, current, voltage, and temperature.
(8) Interrupt is a fundamental concept in computer science, referring to a process in which a computer suspends the execution of the current program during normal operation due to the occurrence of certain urgent events, to handle those events. After the processing is completed, the computer resumes the previously paused program and continues the execution. In terms of hardware, an interrupt is usually triggered by an external device sending a signal to the CPU to request service. For example, an input/output (I/O) device requires CPU processing to complete data transmission. In terms of software, an interrupt may be actively initiated by an operating system or an program to implement functions such as task scheduling, error handling, and system calls. The interrupt mechanism allows a computer to perform a plurality of tasks, thereby improving the CPU utilization and a response speed of the system. Through interrupts, the CPU does not need to constantly query the status of external devices but can process other tasks. When an external device requires CPU processing, it can notify the CPU via an interrupt.

During operation, a computer device may consume energy, such as electrical power. To achieve power saving, certain power-saving technologies may be applied to the CPU, enabling the CPU to operate in a power-saving mode, and thereby reducing the power consumption of the computer device.

Exemplarily, FIG. 1 is a schematic diagram of a CPU power-saving technology. Referring to FIG. 1, the CPU includes a core part 1-1 and an uncore part 1-2. The core part 1-1 may include four processor cores 1-11, with two threads 1-12 provided on each processor core 1-11. The uncore part 1-2 includes an L3 Cache 1-21, a clock 1-22, a QPI controller 1-23, and an integrated memory controller (IMC) 1-24. CPU power-saving technologies applied to processor cores include CPU frequency scaling (Pstate) 1-3, CPU idle (Cstate) 1-4, and Turbo Boost 1-5. The power-saving technology applied to the uncore is implemented through uncore frequency 1-6 control.

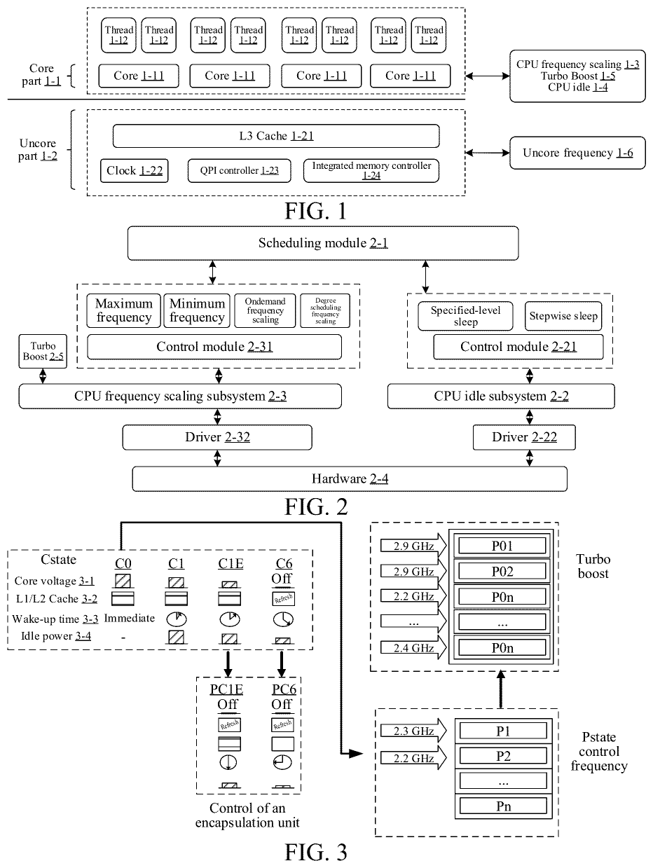

FIG. 2 is a schematic framework diagram of some embodiments of a CPU power-saving technology. Referring to FIG. 2, a scheduling module 2-1 schedules a CPU idle subsystem 2-2 when the CPU is idle. A control module 2-21 in the CPU idle subsystem 2-2 uses different sleep policies (such as stepwise sleep and specified-level sleep) to meet the requirements of different scenarios. Then, the CPU idle subsystem 2-2 drives hardware 2-4 using the corresponding driver 2-22, thereby implementing Cstate adjustment. The scheduling module 2-1 schedules the CPU frequency scaling subsystem 2-3 when the CPU is under load. The control module 2-31 of the CPU frequency scaling subsystem 2-3 meets the requirements of different scenarios using different frequency scaling policies (for example, maximum frequency, minimum frequency, ondemand frequency scaling, and degree scheduling frequency scaling). Then, the CPU frequency scaling subsystem 2-3 drives the hardware 2-4 using the corresponding driver 2-32, thereby implementing Pstate adjustment. In addition, the Turbo Boost 2-5 is also implemented using the CPU frequency scaling subsystem 2-3. In a Turbo Boost mode, the CPU frequency scaling subsystem 2-3 is scheduled, and the CPU frequency scaling subsystem 2-3 invokes the corresponding driver 2-32 to drive the hardware 2-4, thereby implementing Turbo Boost.

There is also a relationship between different power-saving technologies. FIG. 3 is a schematic diagram of a relationship between different power-saving technologies. For Cstate, the CPU sleep state may be divided into four states: C0, C1, C1E, and C6. In the C0 state, the CPU is in an active state (i.e., normally executes instructions), the core voltage 3-1 is the maximum, the L1/L2 Cache 3-2 is retained, and the wake-up time 3-3 is an immediate wake-up. In the C1 state, the core voltage 3-1 is relatively high, the L1/L2 Cache 3-2 is retained, the wake-up time 3-3 is relatively short, and the idle power 3-4 is relatively high. In the C1E state, the core voltage 3-1 is relatively low, the L1/L2 Cache 3-2 is also retained, the wake-up time 3-3 is longer, and the idle power 3-4 is reduced. In the C6 state, the core voltage 3-1 is no longer needed, the L1/L2 Cache 3-2 is refreshed, the wake-up time 3-3 reaches the longest, and the idle power 3-4 is further reduced. It can be seen from this that the components associated with different Cstates vary, and the time taken to return to the C0 state from different Cstates (i.e., power-saving states) also differs. A plurality of processor cores may be encapsulated into one unit. When all processor cores in the encapsulation unit are in an idle state, the entire encapsulation unit may enter a corresponding sleep state, such as a PC1E state (the core voltage is turned off, the L1/L2 Cache is retained, the wake-up time is long, and the idle power is low), or a PC6 state (the core voltage is turned off, the L1/L2 Cache is refreshed, the wake-up time remains normal, and the idle power continues to decrease), to control the encapsulation unit. When the CPU is in a C0 state, for example, the CPU is in an active state, the frequency may be controlled using the Pstate. The operating frequency of the CPU may be divided into n levels from P1 to Pn. The frequency of the P1 level is the maximum, at 2.3 GHZ, and the frequencies from P1 to Pn gradually decrease. For example, the frequency of the P2 level is reduced to 2.2 GHz. When the operating frequency of the CPU reaches the P1 level, the operating frequency of the CPU may be further increased through Turbo Boost. During Turbo Boost, the CPU Turbo frequency may be divided into n levels from P01 to P0n. The operating frequency of P01 is 2.9 GHZ, the operating frequency of P02 is also 2.9 GHZ, the operating frequency of P03 is 2.8 GHZ, and so on, with the operating frequency of P0n being 2.4 GHz.

A brief description of the implementation frameworks of different power-saving technologies is provided below.

The Cstate technology is configured to control the power consumption of the CPU when it is idle. Since the delay in exiting the Cstate is relatively large, it may affect system performance. When the CPU is idle, the system schedules the Idle process, which invokes an interface of the idle subsystem to put the CPU into the sleep mode. The idle subsystem mainly includes two parts: the policy and the driver. The policy part uses a plurality of policies to meet the requirements of different scenarios. Table 1 provides descriptions of the different sleep policies. A common approach is to collect load information, scheduling information, delay information, and interrupt information of the system, then predict the idle time of the system based on the collected information, and enter a specific sleep depth according to the predicted idle time. The driver part may be responsible for driving the hardware. Common drivers include the acpi_idle driver and the intel_idle driver. The acpi_idle driver depends on an advanced configuration and power interface (ACPI) table, which is populated by a input/output system (BIOS). If the BIOS disables Cstate-related functions, the driver cannot function properly. In contrast to the acpi_idle driver, the intel_idle driver does not depend on ACPI.

TABLE 1

| Policy | Description |
|---|---|
| Ladder (i.e., | A shallow-to-deep sleep policy, where shallow sleep is |
| stepwise sleep) | first performed, and if the sleep time is long enough, |
| | the system gradually enters deep sleep |
| Menu (specified- | Determine an appropriate sleep depth according to the |
| level sleep) | state of the system and directly enter sleep |

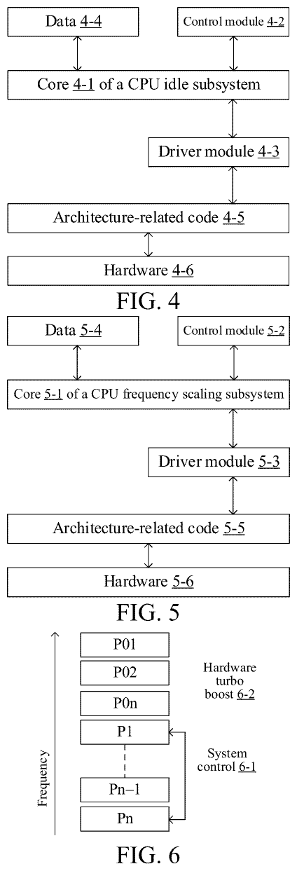

FIG. 4 is a schematic diagram of some embodiments of Cstate technology. The core 4-1 of the CPU idle subsystem first abstracts the control module 4-2 and driver module 4-3 of the idle subsystem. The policy part is implemented by the control module 4-2, for example, a main object of the control module 4-2 is to balance performance and power consumption according to the system state and the data 4-4. The driver part is implemented by the driver module 4-3, for example, the driver module 4-3 invokes the architecture-related code 4-5 to drive the hardware 4-6.

The Pstate technology may be implemented through the CPU frequency scaling subsystem. The CPU frequency scaling subsystem may be subdivided into a policy part and a driver part. The policy part mainly implements a plurality of frequency scaling policies to meet the requirements of different scenarios. Table 2 provides descriptions of different policies. A common approach is to collect load information, scheduling information, delay information, and interrupt information of the system, then predict the system load and the CPU's main frequency according to the load conditions. The driver part is responsible for driving the hardware. Practically, the two common drivers of the CPU frequency scaling subsystem are the acpi_freq driver and the intel_pstate driver. The intel_pstate driver has higher priority and is preferred. The acpi_freq driver depends on the ACPI table, which is usually populated by the BIOS. If the BIOS disables frequency scaling, the acpi_freq driver cannot function properly.

TABLE 2

| Policy | Description |
|---|---|
| Performance | Operate at maximum frequency |
| Powersave | Operate at minimum frequency |
| Userspace | Operate at specified frequency |
| (specified mode) | |
| Ondemand | Rapid and dynamic frequency adjustment as needed: |
| | operating at maximum frequency when there is a task, |
| | and reducing the operating frequency during idle |
| | periods |
| Conservative | Similar to the Ondemand mode, the difference lies in |
| | the gradual increase of the frequency |
| Schedutil | Frequency adjustment based on the scheduler |

Exemplarily, FIG. 5 is a schematic diagram of some embodiments of Pstate technology. The core 5-1 of the CPU frequency scaling subsystem first abstracts the control module 5-2 and driver module 5-3 of the frequency scaling subsystem. The policy part is implemented by the control module 5-2, for example, a main object of the control module 5-2 is to adjust the CPU main frequency according to the system state and the data 5-4. The driver part is implemented by the driver module 5-3, for example, the driver module 5-3 invokes the architecture-related code 5-5 to drive the hardware 5-6.

Turbo Boost allows the CPU to operate at a base clock rate under light load and increase to a higher clock rate under heavy load. Operating at a base clock rate (cycles per second) reduces CPU power consumption and heat generation. When a higher rate is needed, Turbo Boost dynamically increases the clock rate to compensate, which may be referred to as “algorithmic overclocking”. In other words, Turbo Boost mode can increase the CPU's processing speed to the maximum Turbo frequency within safe temperature and power limits, thereby enhancing the performance of both single-threaded and multi-threaded softwares.

Exemplarily, FIG. 6 is a schematic framework diagram of Turbo Boost technology. Operating frequencies from P1 to Pn are controlled by the system control 6-1, for example, by the driver module of the CPU frequency scaling subsystem. When the frequency is at the maximum frequency P1, hardware Turbo Boost 6-2 is triggered. For example, the operating frequency of a processor core that has already reached P1 is further increased to P0n or even P01. The maximum frequency during Turbo Boost depends on the number of processor cores in an active state or the number of processor cores operating at P1 to Pn. Therefore, Turbo Boost may be simply understood as some processor cores relinquishing power to the turbo-boosted processor cores when the total power remains unchanged, allowing the turbo-boosted processor cores to operate at a higher frequency. Certainly, if all processor cores are operating at the maximum frequency P1, they may all operate at the same Turbo frequency.

It may be known from the foregoing introduction that, in the related technology, the power-saving state of a single CPU is dynamically adjusted based on its load condition, for example, the adjustment of the power-saving state is performed at the granularity of the CPU load. However, the load of a single CPU is highly variable. If a to-be-processed task appears after the CPU enters a power-saving state, it may exit the power-saving state and return to an active state for processing. Exiting the power-saving state usually requires a amount of time to respond. For example, when a processor core wakes up from a higher-level sleep state to an active state, a time delay occurs, leading to a longer processing time for the to-be-processed task. Consequently, the operating performance of the computer device is affected. It may be seen from the above that in the related technology, implementing power-saving measures for the computer device may adversely affect its operating performance, for example, it is difficult to achieve both maintaining the operating performance of the computer device and achieving power saving for the computer device simultaneously.

Some embodiments provide a processor scheduling method and apparatus, an electronic device, a computer-readable storage medium, and a computer program product, which ensure the operating performance of the computer device while achieving power saving for the computer device. The following describes embodiments of the computer device according to some embodiments. The computer device according to some embodiments may be implemented as various types of terminals, such as laptops, tablets, desktops, set-top boxes, and mobile devices, or as a server. some embodiments in which the computer device is implemented as a server is to be described below.

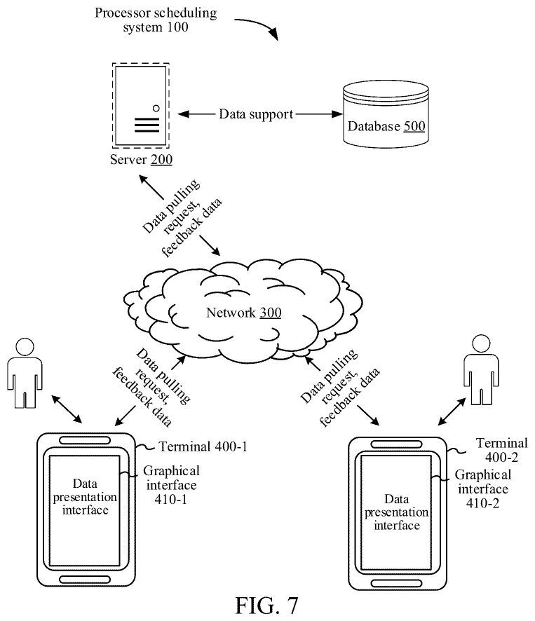

Referring to FIG. 7, FIG. 7 is a schematic architectural diagram of a processor scheduling system according to some embodiments. To implement and support a processor scheduling operation, in a processor scheduling system 100, terminals (a terminal 400-1 and a terminal 400-2 are exemplarily shown) are connected to a server 200 through a network 300. The network 300 may be a wide area network, a local area network, or a combination of both. A database 500 is also included in the processor scheduling system 100 to provide data support to the server 200. The database 500 may be independent of the server 200 or integrated within the server 200. FIG. 7 shows the case where the database 500 is independent of the server 200.

The server 200 is configured to: receive data pulling requests sent by the terminal 400-1 and the terminal 400-2, and decompose the data delivery process for the terminal 400-1 and the terminal 400-2 into to-be-processed tasks; acquire a total load of N processors; generate, based on the total load, a processor bitmap of the N processors, where the processor bitmap is configured to distinguish an active processor and an idle processor in the N processors; and process, based on the processor bitmap, a to-be-processed task on the active processor, and adjust the idle processor to a target power-saving mode to complete the scheduling of the N processors, followed by returning feedback data for the data pulling requests to the terminal 400-1 and the terminal 400-2.

The terminal 400-1 and the terminal 400-2 are configured to display the feedback data delivered by the server 200 in data presentation interfaces shown by a graphical interface 410-1 and a graphical interface 410-2, respectively, for the user to view.

Some embodiments may be implemented using cloud technology, which refers to a hosting technology that unifies a series of resources, such as hardware, software, and networks, within a wide area network or a local area network to enable the calculation, storage, processing, and sharing of data.

Cloud computing is a general term for network technology, information technology, integration technology, management platform technology, software technology, and others, applied based on the business model of cloud computing. It can form a resource pool that is used on demand, flexibly and conveniently. Cloud computing technology is becoming a key support. Backend services of the technical network system require a large amount of computing and storage resources, which need to be implemented through cloud computing.

Exemplarily, the server 200 may be an independent physical server, a server cluster or distributed system composed of a plurality of physical servers, or a cloud server providing cloud computing services such as cloud services, cloud databases, cloud computing, cloud functions, cloud storage, network services, cloud communication, middleware services, domain name services, security services, content delivery networks (CDN), and big data and artificial intelligence (AI) platforms. The terminal 400-1 and terminal 400-2 may be a smartphone, a tablet, a laptop, a desktop computer, a smart speaker, a smartwatch, an in-vehicle terminal, or the like, but are not limited thereto. The terminal may be connected directly or indirectly to the server via wired or wireless communication, without limitation in some embodiments.

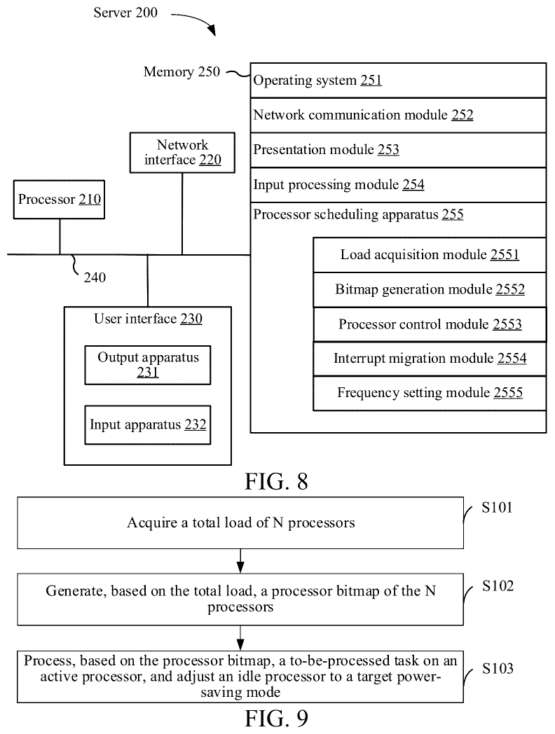

Referring to FIG. 8, FIG. 8 is a schematic structural diagram of a server (some embodiments of a computer device) in FIG. 7 according to some embodiments. The server 200 shown in FIG. 8 includes N processors 210 (N≥2), a memory 250, at least one network interface 220, and a user interface 230. The components in the server 200 are coupled together through a bus system 240. The bus system 240 is configured to implement connection and communication between the components. In addition to a data bus, the bus system 240 further includes a power bus, a control bus, and a state signal bus. However, for clarity, all types of buses in FIG. 8 are labeled as the bus system 240.

The processor 210 may be an integrated circuit chip with signal processing capabilities, such as a general-purpose processor, a digital signal processor (DSP), or other programmable logic devices, discrete gates, transistor logic devices, or discrete hardware components. The general-purpose processor may be a microprocessor, any processor, or the like.

The user interface 230 includes one or more output apparatuses 231 that facilitate the presentation of media content, including one or more speakers and/or one or more visual displays. The user interface 230 further includes one or more input apparatuses 232, including user interface components that facilitate user input, such as a keyboard, a mouse, a microphone, a touchscreen display, a camera, and other input buttons and controls.

The memory 250 may be removable, non-removable, or a combination thereof. The exemplary hardware device includes a solid-state memory, a hard disk drive, an optical disc drive, and the like. The memory 250 includes one or more storage devices away from the processor 210 in physical positions.

The memory 250 includes a volatile memory or a non-volatile memory, or may include both a volatile memory and a non-volatile memory. The non-volatile memory may be a read-only memory (ROM), and the volatile memory may be a random-access memory (RAM). The memory 250 described in some embodiments is to include any other suitable type of memory.

In some embodiments, the memory 250 may store data to support various operations. Examples of such data include programs, modules, data structures, or subsets or supersets thereof, as exemplified below.

An operating system 251 includes system programs designed to handle various system services and perform hardware-related tasks, such as the framework layer, core library layer, or driver layer, to implement services and process hardware-based tasks.

A network communication module 252 is configured to connect to other computer devices via one or more (wired or wireless) network interfaces 220. The exemplary network interfaces 220 include Bluetooth, Wi-Fi, universal serial bus (USB), and the like.

A presentation module 253 is configured to enable the presentation of information (for example, a user interface for operating peripheral devices and displaying content and information) through one or more output apparatuses 231 (for example, display screens or speakers) associated with the user interface 230.

An input processing module 254 is configured to detect one or more user inputs or interactions from one or more input apparatuses 232 and translate the detected inputs or interactions.

In some embodiments, the processor scheduling apparatus according to some embodiments may be implemented in software. FIG. 8 shows a processor scheduling apparatus 255 stored in the memory 250, which may be software in the form of a program, a plugin, and the like. The processor scheduling apparatus includes the following software modules: a load acquisition module 2551, a bitmap generation module 2552, a processor control module 2553, an interrupt migration module 2554, and a frequency setting module 2555. These modules are logical, so they may be arbitrarily combined or further split based on the functionality implemented. The functions of each module are explained below.

In other embodiments, the processor scheduling apparatus according to some embodiments may be implemented in hardware. As an example, the processor scheduling apparatus according to some embodiments may be a processor in the form of a hardware decoding processor, programmed to perform the processor scheduling method according to some embodiments. For example, the processor in the form of a hardware decoding processor may use one or more application-specific integrated circuits (ASIC), a DSP, a programmable logic device (PLD), a complex programmable logic device (CPLD), a field-programmable gate array (FPGA), or other electronic components.

In some embodiments, the terminal or the server (both of which may serve as possible implementations of the computer device) may implement the processor scheduling method according to some embodiments by executing a computer program. For example, the computer program may be a native program or software module within an operating system; it may be a native application (APP), i.e., a program that may be installed on the operating system to run, such as a power management APP; it may be a mini-program, which only may be downloaded into a browser environment to run; or it may be a mini-program that can be embedded within any APP. In summary, the foregoing computer program may be any form of an APP, module, or plugin.

Some embodiments may be applied to processor scheduling scenarios in computer devices such as terminals and servers. The following describes the processor scheduling method according to some embodiments with reference to exemplary operations and implementations of the computer device according to some embodiments.

Referring to FIG. 9, FIG. 9 is a schematic flow diagram I of a processor scheduling method according to some embodiments. A description is provided in combination with the operations shown in FIG. 9.

S101: Acquire a total load of N processors.

Some embodiments are implemented in a scenario where work scheduling is performed for N processors in a computer device, aiming to ensure the operating performance of the computer device while achieving power saving for the computer device. In some embodiments, the computer device first performs load calculation on each processor owned thereby, and counts a total load of the N processors to obtain the total load of the N processors, N≥2, for example, in some embodiments, the computer device schedules the work of at least two processors owned thereby.

The load of each processor refers to the statistical information of threads that are in a running state or a runnable state. Therefore, the load of each processor can preliminarily reflect the computational resources, for example, computing power, for each processor.

The processor in some embodiments may refer to a CPU or a graphics processing unit (GPU). Some embodiments are not limited to these.

In some embodiments, S101 in FIG. 9 may be implemented through the following processing: performing load sampling on each processor to obtain load information of each processor; and accumulating N pieces of load information corresponding to the N processors to obtain the total load of the N processors.

The computer device may perform load sampling on each processor using existing load sampling algorithms (such as the pruned exact linear time (PELT) algorithm or the windows-assist load tracing (WALT) algorithm) to obtain load information for each processor. The computer device may also complete load sampling by reading the power consumption of each processor and determining the load information based on the power-consumption-load relationship.

S102: Generate, based on the total load, a processor bitmap of the N processors.

The computer device divides the N processors into idle processors and active processors based on the total load obtained through statistics. Specifically, it identifies the active processors from the N processors and determines the processors, other than the active processors, as idle processors. A bitmap is generated using the processor identifiers corresponding to the N processors. In this bitmap, the processor identifiers of the active processors and the processor identifiers of the idle processors are marked in different ways. The completed bitmap is then determined as the processor bitmap. For example, the processor identifier of the active processor may be marked as 1, while the processor identifier of the idle processor may be marked as 0. Therefore, the obtained processor bitmap may be configured to distinguish the active processor and the idle processor in the N processors.

The active processor refers to a processor that may remain active for a subsequent (i.e., future) period, allowing it to quickly respond to and process the subsequent to-be-processed tasks. As a result, all subsequent to-be-processed tasks may be concentrated on the active processor, and the corresponding operating frequency may be adjusted for the active processor to ensure the task-processing performance of the computer device. The idle processor refers to a processor that may remain idle for a subsequent (i.e., future) period and does not participate in processing any to-be-processed tasks subsequently. Therefore, these idle processors may be directly adjusted to a power-saving mode, for example, the idle processors are controlled to enter deep sleep, or the idle processors are controlled to operate at a minimum frequency, to reduce the power consumption of the computer device.

In some embodiments, the number of active processors is directly proportional to the total load of the N processors, while the number of idle processors is inversely proportional to the total load of the N processors. If the computer device divides the N processors into M active processors and N-M idle processors, M gradually increases as the total load increases (1≤M≤N), while N-M gradually decreases. In this way, a processor bitmap configured to distinguish an active processor and an idle processor in the N processors may be generated based on the total load of the N processors. This allows the N processors to be divided into active processors and idle processors using the global load as a granularity, enabling quick scheduling of the N processors while ensuring the processing performance and power saving of the processors.

The computer device may generate the processor bitmap in various ways. The following describes the process of generating the processor bitmap.

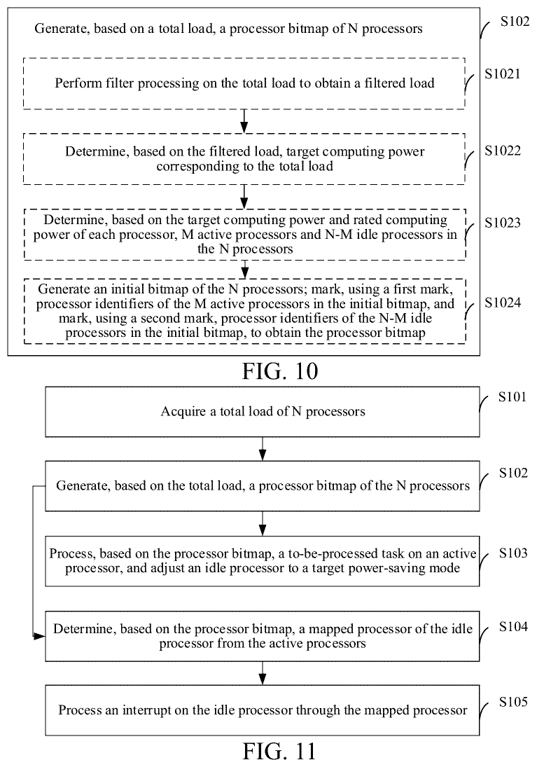

Referring to FIG. 10, FIG. 10 is a schematic flow diagram II of a processor scheduling method according to some embodiments. In some embodiments, S102 in FIG. 9 may be implemented through S1021 to S1024 as follows.

S1021: Perform filter processing on the total load to obtain a filtered load.

The load of each processor does not change steadily. For example, the load may suddenly increase and then decrease at a particular moment, resulting in significant fluctuations in the processor load. Although superimposing loads of the N processors can reduce the fluctuations to some extent (i.e., peaks and troughs cancel each other out), the fluctuations cannot be completely eliminated. As a result, the total load remains smooth. However, a smooth total load may lead to the need for frequent generation of the processor bitmap (in fact, sudden changes in the total load are very short-lived and do not require a re-division of active processors and idle processors). Therefore, to minimize the unnecessary number of times the processor bitmap is generated, the computer device may perform filtering processing on the total load, making the total load smoother, thus obtaining a filtered load.

In some embodiments, the computer device may filter the total load using historical loads. In more detail, S1021 in FIG. 10 may be implemented through the following processing: acquiring a historical load, and performing weighted fusion on the historical load and the total load, to obtain the filtered load. A weighted weight of the historical load is greater than a weighted weight of the total load. Specifically, the filtered load is calculated as: Filtered load=historical load * weighted weight of historical load+total load * weighted weight of total load.

In other words, in some embodiments, the computer device calculates a smoother load using the historical load over historical time and the total load obtained from current statistics, to obtain the filtered load. Because the difference between the historical load and the real-time load is not very large, a relatively larger weighted weight may be assigned to the historical load, while a smaller weighted weight is assigned to the total load. This allows the historical load to be given more consideration during the smoothing process of load estimation, thereby ensuring the accuracy of the filtered load.

In other embodiments, the computer device may further filter the total load using some common filtering algorithms, for example, filtering the total load using a mean filtering algorithm, or filtering the total load using a clipping filtering algorithm. Some embodiments are not limited to these.

In this way, S1021 enables the total load of the N processors to be smoother, reducing the impact of processor load fluctuations, thereby decreasing the number of times the processor bitmap is generated, improving the accuracy of processor bitmap generation, and reducing the consumption of device resources for the computer device for generating the processor bitmap.

S1022: Determine, based on the filtered load, target computing power corresponding to the total load.

After obtaining the smoother filtered load, the computer device may determine, based on the filtered load, the total computing power for processing the total load, and define the total computing power as the target computing power corresponding to the total load. When determining the target computing power, the computer device may determine the target computing power solely based on the filtered load, or it may determine the final target computing power by considering other factors, such as the computing power fluctuation, in addition to the filtered load.

In some embodiments, S1022 in FIG. 10 may be implemented through the following processing: determining matching computing power corresponding to the filtered load, and determining the matching computing power as the target computing power corresponding to the total load.

For example, the computer device may directly use the matching computing power corresponding to the filtered load, which refers to the computing power for processing the filtered load (this may be the number of threads needed to process the filtered load, or a target multiple of the number of threads, such as 1.5 times), as the target computing power for the total load. In this way, the target computing power can precisely meet the processing requirements of the total load, ensuring that computing power is not wasted and improving the utilization of computing resources.

In other embodiments, S1022 in FIG. 10 may be implemented through the following processing: determining matching computing power and reserved computing power corresponding to the filtered load; superimposing the matching computing power and the reserved computing power to obtain first superimposed computing power; and adding fluctuating computing power corresponding to load fluctuation to the first superimposed computing power to obtain second superimposed computing power, and determining the second superimposed computing power as the target computing power corresponding to the total load.

The reserved computing power refers to the additional computing power that the processor needs beyond the computing power for processing the filtered load. The reserved computing power may be calculated based on the matching computing power for the filtered load and the utilization of the processor. For example, when the matching computing power of the filtered load is Cma, and the utilization of the processor is 50%, the reserved computing power may be Cma. The computer device considers the reserved computing power when determining the target computing power to handle unexpected situations of a single processor, such as processor congestion, ensuring the processor operates normally.

In addition, the computer device also may consider load fluctuations, for example, by adding fluctuating computing power to the first superimposed computing power to handle the load fluctuation. The fluctuating computing power may either be a preset value or the average value of the total load and filtered load. Some embodiments are not limited to these.

In some embodiments, the final target computing power is determined by simultaneously considering the matching computing power, reserved computing power, and fluctuating computing power of the filtered load. This may ensure that a sufficient amount of target computing power is obtained for the total load, thereby ensuring that a sufficient number of active processors are available to maintain the operating performance of the computer device.

S1023: Determine, based on the target computing power and rated computing power of each processor, M active processors and N-M idle processors in the N processors.

After obtaining the target computing power, the computer device may read the rated computing power of each processor, which refers to the maximum computing power of each processor. Based on the target computing power and the read rated computing power, the computer device then determines how many processors are needed to meet the target computing power, i.e., determines the number M of active processors. Next, the computer device may select M processors from the N processors as active processors, and assign the remaining N-M processors as idle processors, thereby completing the division of active processors and idle processors from the N processors, 1≤M<N.

In some embodiments, S1023 in FIG. 10, which is the process of determining, based on the target computing power and rated computing power of each processor, M active processors and N-M idle processors in the N processors, may be implemented through the following processing: determining, according to the target computing power and the rated computing power of each processor, the first number of processors to achieve the target computing power; determining, according to the number of tasks corresponding to the total load and a task queuing capability of each processor, the second number of processors to complete the number of tasks; determining the greater of the first number of processors and the second number of processors as the number M of the active processors; and determining M processors with a maximum load in the N processors as the active processors, and determining N-M processors different from the active processors in the N processors as the idle processors.

In other words, the computer device first determines how many processors are needed to reach the target computing power by reading the rated computing power of each processor. For example, when the rated computing power of all processors is the same, the first number of processors is determined as the ratio of the target computing power to the rated computing power. When the rated computing power of each processor differs, the rated computing power values may be sorted in descending order to form a rated computing power sequence. Then, the rated computing power is superposed from the head of the rated computing power sequence. When a superposition result reaches or exceeds the target computing power, the number of all processors participating in the superposition is used as the first number of processors.

The task queuing capability of each processor refers to the maximum number of tasks that can be queued in the processor. For example, when the task queuing capability of a processor is 2, it indicates that at most two tasks (i.e., processes) may be queued in the processor, waiting to be processed by the processor. The larger the task queuing capability of a processor, the longer the waiting time for the last task in the queue, which may impact the operating performance of the computer device. Therefore, the computer device also may acquire the number of tasks corresponding to the total load by counting the tasks that contribute to the total load. Then, by considering the number of tasks and the task queuing capability of each processor, the computer device determines the number of processors to complete the number of tasks, thereby obtaining the second number of processors.

Next, the computer device may select the greater of the first number of processors and the second number of processors as the number M of the active processors. This may ensure a sufficient number of active processors, maintaining the processing performance of the computer device in a power-saving state. Finally, the computer device may select the M processors with the maximum load (the M processors with the maximum load are selected because a high-load processor takes longer to enter the power-saving mode compared to a low-load processor) from the N processors as the active processors. The remaining N-M processors are assigned as idle processors, thereby completing the division of active processors and idle processors. In this way, the selected idle processor may be controlled to enter the power-saving mode more quickly, thereby improving the scheduling efficiency of the processor and the power-saving effect of the computer device.

Certainly, in other embodiments, S1023 in FIG. 10, which is the process of determining, based on the target computing power and rated computing power of each processor, M active processors and N-M idle processors in the N processors, may be further implemented through the following processing: determining, according to the target computing power and the rated computing power of each processor, the first number of processors to achieve the target computing power; determining the first number of processors as the number M of the active processors; and selecting M processors from the N processors as the active processors, and determining N-M processors different from the active processors in the N processors as the idle processors.

For example, the computer device may directly determine the number of active processors based solely on the target computing power and the rated computing power of each processor, without considering other factors. This simplifies and speeds up the process of determining the number M of active processors, improves the speed of dividing active processors and idle processors, and further improves the scheduling efficiency of the processor and the power-saving effect of the computer device.

S1024: Generate an initial bitmap of the N processors; mark, using a first mark, processor identifiers of the M active processors in the initial bitmap, and mark, using a second mark, processor identifiers of the N-M idle processors in the initial bitmap, to obtain the processor bitmap.

The second mark is different from the first mark. The computer device first generates an initial bitmap using the processor identifiers (such as the names or IDs of the processors) of the N processors, so that the obtained initial bitmap may be regarded as an array or queue composed of the processor identifiers of the N processors. Next, the computer device determines a processor identifier of each active processor in the initial bitmap, marks the processor identifier of each active processor using the first mark, and then determines a processor identifier of each idle processor in the initial bitmap, and marks the processor identifier of each idle processor using the second mark. Once the processor identifiers in the initial bitmap have been marked, the computer device obtains the processor bitmap.

In some embodiments, the first mark and the second mark may be two different values. For example, the first mark may be 1, and the second mark may be 0. The first mark and the second mark may be two different logical values. For example, the first mark may be true, and the second mark may be false.

In some embodiments, the first mark and the second mark may be directly written onto the initial bitmap. As a result, each bit in the obtained processor bitmap contains two elements: a processor identifier and its corresponding mark. In other embodiments, the first mark and the second mark may be recorded using a mask bitmap of the same size as the initial bitmap. For example, each bit in the initial bitmap represents a processor identifier, and each bit in the mask bitmap represents a mark corresponding to the processor identifier. In this way, the processor bitmap is formed by two bitmaps: the initial bitmap and the mask bitmap.

In some embodiments, the computer device filters the total load, then determines the target computing power using the filtered load, and divides the active processors and idle processors by comprehensively considering the target computing power and the rated computing power. This approach not only may ensure that the number of active processors is sufficient to handle the total load, thus ensuring the accuracy of the processor bitmap, but also reduces the impact of load fluctuations on the division of active processors and idle processors, thereby minimizing unnecessary generation process of the processor bitmap.

In other embodiments, S102 in FIG. 9 may be further implemented through the following processing: performing a difference calculation between the total load of the N processors and a plurality of total historical loads corresponding to the plurality of historical bitmaps to obtain a difference in total load, and determining a historical bitmap corresponding to a total historical load, where the difference in total load is less than a difference threshold, as the processor bitmap of the N processors. In this way, by determining the difference in total load between the current total load and the total historical load, and selecting a historical bitmap where the difference in total load is less than a difference threshold from the historical bitmaps of the total historical load, the processor bitmap for the N processors may be determined. This approach simplifies the generation logic of the processor bitmap and improves the generation efficiency of the processor bitmap.

S103: Process, based on the processor bitmap, a to-be-processed task on the active processor, and adjust the idle processor to a target power-saving mode.

After obtaining the processor bitmap, the computer device may select active processors based on the marks corresponding to different processor identifiers in the processor bitmap, and allocate the to-be-processed tasks to the active processors for processing, thereby ensuring the operating performance of the computer device. The idle processors do not need to process the to-be-processed tasks and remain in an idle state. The computer device then adjusts the idle processors to the target power-saving mode to reduce power consumption, thereby achieving power saving for the computer device.

The target power-saving mode may be set according to actual needs. The target power-saving mode in some embodiments may refer to the sleep with the maximum depth, the processor frequency being adjusted to a minimum frequency, or any other mode that can achieve power saving.

In some embodiments, the active processor operates in a maximum performance mode, a processor frequency of the maximum performance mode is a maximum frequency, and a sleep depth is a minimum depth. The processor frequency of the target power-saving mode is a minimum frequency, and the sleep depth is a maximum depth. In this way, the processing performance of the computer device is maximized, while the power consumption of the computer device is minimized.

In other embodiments, the active processor operates in a specified performance mode, a processor frequency of the specified performance mode is a specified frequency, and a sleep depth is a minimum depth. The processor frequency of the target power-saving mode is a minimum frequency, and the sleep depth is a specified depth. The specified frequency may be set according to a number of to-be-processed tasks, and the specified frequency may be less than a maximum frequency. The specified depth may be set according to power-saving requirements, and the specified depth may be less than a maximum depth. In this way, (1) the performance mode of the active processor is controlled based on the situation of the to-be-processed tasks, ensuring the processing performance of the computer device for the to-be-processed tasks and a reduction in resource consumption of the devices to achieve power saving. (2) The sleep depth of the idle processor is controlled based on power-saving requirements, ensuring the power-saving effect of the computer device and reducing the time for the idle processor to exit the power-saving mode.

Compared to the related technology, adjusting the power-saving state based on the load condition of a single CPU affects the operating performance of the computer device, meaning that power-saving cannot be achieved without compromising the operating performance of the computer device. In some embodiments, the computer device generates a processor bitmap based on the total load of the N processors, which is configured to distinguish an active processor and an idle processor in the N processors. Then, using the global load as a granularity, the computer device divides the N processors into active processors and idle processors based on the processor bitmap of the N processors. This allows: (1) A to-be-processed task is processed on the active processor, thereby enabling a quick response to the to-be-processed task and ensuring the processing performance of the computer device; (2) The idle processor is adjusted to the target power-saving mode, allowing the idle processor to operate in a low-power state, thereby achieving power saving for the computer device. In this way, the operating performance of the computer device is ensured while achieving power saving for the computer device. In addition, in some embodiments, the computer device directly adjusts the idle processor to the target power-saving mode, reducing the time needed to balance performance and power consumption, thereby reducing the time for the computer device to achieve power saving and improving the efficiency of power-saving implementation.

Based on FIG. 9, referring to FIG. 11, FIG. 11 is a schematic flow diagram III of a processor scheduling method according to some embodiments. In some embodiments, after S102 in FIG. 9, the method further includes the following processing: S104 to S105, as described below.

S104: Determine, based on the processor bitmap, a mapped processor of the idle processor from the active processors.

Since the idle processor may adjust to the target power-saving mode in a subsequent time to achieve power saving, it does not respond to interrupts, similar to how the to-be-processed tasks are handled. Therefore, after determining the idle processor, the computer device may determine, from the active processor with reference to the processor bitmap, for each idle processor, a mapped processor that can process an interrupt on the idle processor.

In some embodiments, S104 in FIG. 11 may be implemented through the following processing: deleting a processor identifier of the idle processor from the processor bitmap to obtain a sparse bitmap; determining a remainder obtained by dividing the processor identifier of the idle processor by a length of a bitmap array; and determining, in the bitmap array, a target identifier corresponding to the remainder, and determining an active processor corresponding to the target identifier as the mapped processor.

For each idle processor, the computer device locates a processor identifier of the idle processor from the processor bitmap, and deletes the processor identifier from the processor bitmap. The resulting bitmap after the deletion operation is the sparse bitmap. Then, the computer device rearranges the sparse bitmap into a compact array, which is the bitmap array, obtained by compactly arranging the sparse bitmap. The computer device then determines a remainder obtained by dividing the processor identifier of the idle processor by a length of a bitmap array, referred to as the identifier remainder. Finally, according to the identifier remainder, the processor identifier corresponding to the identifier remainder is determined from the bitmap array as the target identifier. Specifically, the processor identifier indexed at the original position of the processor identifier of the idle processor is selected, thereby selecting the active processor corresponding to the target identifier as the mapped processor. In this way, a corresponding active processor may be selected for each idle processor as the mapped processor, enabling proper allocation of interrupts to idle processors and ensuring the operating performance of the processor.

Exemplarily, if the processor bitmap is [0,1,2,3,4,5,6,7,8,9] and the processor identifier of an idle processor is 3, the sparse bitmap is obtained by removing 3 from the bitmap. The bitmap array corresponding to the sparse bitmap is [0,1,2,4,5,6,7,8,9], and the length of the bitmap array of the sparse bitmap is 9. The computer device determines the remainder of 3 divided by 9, which is 3. Accordingly, the identifier remainder is 3. Finally, the computer device indexes the processor identifier from the bitmap array using the obtained identifier remainder (i.e., the processor identifier at the original position of 3), and the obtained target identifier is 4. Therefore, the active processor with a processor identifier of 4 serves as the mapped processor for the idle processor.

In some embodiments, S104 in FIG. 11 may be further implemented through the following processing: deleting a processor identifier of the idle processor from the processor bitmap to obtain a sparse bitmap; determining any processor identifier in the sparse bitmap as a target identifier, and determining an active processor corresponding to the target identifier as the mapped processor.

In other words, the computer device may select a mapped processor for the idle processor from the existing active processors to complete the determination of the mapped processor. In this way, the determination logic of the mapped processor may be simplified, and the determination efficiency of the mapped processor may be improved.

S105: Process an interrupt on the idle processor through the mapped processor.

Then, after an interrupt originally bound to the idle processor is triggered, the computer device may migrate the interrupt to the mapped processor for processing, ensuring that all interrupts are processed on the active processors, while the idle processor remains in the target power-saving mode, thereby achieving power saving for the computer device.

In some embodiments, S105 in FIG. 11 may be implemented through the following processing: processing a network adapter interrupt on the idle processor through the mapped processor to obtain a data packet of the network adapter interrupt; distributing the data packet to the N processors; and migrating, when the data packet is distributed to the idle processor, the data packet to the mapped processor, and performing soft interrupt processing on the data packet through the mapped processor.

In some embodiments, the computer device may re-affinize the network adapter interrupt originally bound to an idle processor to a mapped processor of the idle processor for processing, to generate the corresponding data packet. The data packet is then further distributed across different processors for soft interrupt processing. When the data packet is distributed to the idle processor, the computer device may affinize the data packet to the mapped processor, to perform a soft interrupt. In other words, for the network adapter interrupt and soft interrupt on an idle processor, the computer device may re-affinize them to a mapped processor for corresponding processing.

In other embodiments, S105 in FIG. 11 may be implemented through the following processing: processing a network adapter interrupt on the idle processor through the mapped processor to obtain a data packet of the network adapter interrupt; and distributing the data packet to any active processor for soft interrupt processing.

In some embodiments, the computer device determines a corresponding mapped processor for an idle processor and re-affinizes the interrupt bound to the idle processor to the corresponding mapped processor for processing, ensuring that the interrupt originally bound to the idle processor is correctly responded to, thereby guaranteeing a high success rate of interrupt execution.

In some embodiments, after the processing, based on the processor bitmap, a to-be-processed task on the active processor, and adjusting the idle processor to a target power-saving mode, the method may further include the following processing: setting, using a maximum frequency parameter, a maximum frequency of the active processor during Turbo Boost.

This is because when a processor undergoes Turbo Boost, the maximum frequency during Turbo Boost changes depending on the number of the turbo-boosted processors. For example, as the number of the turbo-boosted processors increases, the maximum frequency during Turbo Boost decreases, whereas as the number of the turbo-boosted processors decreases, the maximum frequency during Turbo Boost increases. In some embodiments, since only the active processors operate at the maximum frequency and meet the conditions for Turbo Boost, only a number of active processors, for example, M processors, participate in Turbo Boost, which increases the maximum frequency during Turbo Boost. However, the increase in the maximum frequency during Turbo Boost is not conducive to power consumption control. Therefore, the computer device limits the maximum frequency of the active processor during Turbo Boost according to the maximum frequency parameter, thus facilitating power consumption control of the active processor and helping achieve power saving for the computer device.

The maximum frequency parameter may be set according to actual requirements, for example, set to 2.8 GHz or 3.0 GHz. Some embodiments are not limited to this.

The following describes some embodiments practically.

Some embodiments are implemented in a scenario where a server (referred to as a computer device) performs scheduling on a CPU, which not only may ensure the operating performance of the server, but also achieves power saving for the server.

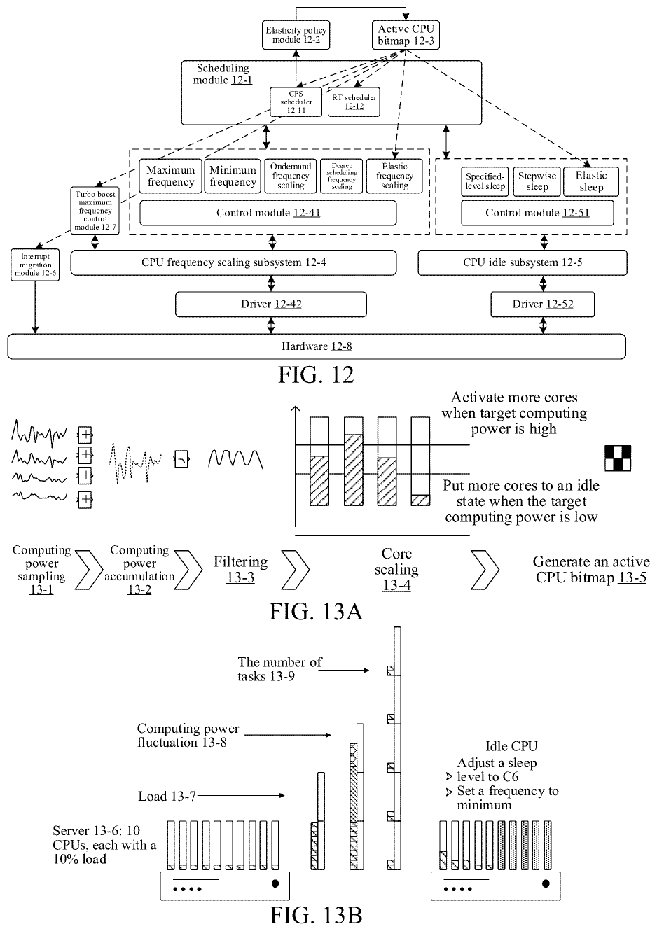

FIG. 12 is a schematic diagram of a server scheduling framework for a CPU according to some embodiments. Referring to FIG. 12, the scheduling framework includes a scheduling module 12-1, an elasticity policy module 12-2, an active CPU bitmap 12-3 (referred to as a processor bitmap), a CPU frequency scaling subsystem 12-4, a CPU idle subsystem 12-5, an interrupt migration module 12-6, and a Turbo Boost maximum frequency control module 12-7. The scheduling module 12-1 invokes the elasticity policy module 12-2 to generate the active CPU bitmap 12-3 according to all CPU loads, and then schedules the CPU frequency scaling subsystem 12-4, the CPU idle subsystem 12-5, the interrupt migration module 12-6, and the Turbo Boost maximum frequency control module 12-7 based on the active CPU bitmap 12-3. More specifically, the active CPU bitmap 12-3 influences a completely fair scheduler (CFS) 12-11 and a POSIX realtime (RT) scheduler 12-12 in the scheduling module 12-1. These two schedulers invoke a control module 12-41 in the CPU frequency scaling subsystem 12-4 to select an elastic frequency scaling policy from various frequency scaling policies (such as maximum frequency, minimum frequency, ondemand frequency scaling, degree scheduling frequency scaling, and elastic frequency scaling) for performing frequency scaling, and drive the hardware 12-8 through the corresponding driver 12-42. The control module 12-51 in the CPU idle subsystem is invoked to select an elastic sleep policy from various sleep policies (such as stepwise sleep, specified-level sleep, and elastic sleep) for sleep control, and drives the hardware 12-8 through the corresponding driver 12-52. The interrupt migration module 12-6 migrates the interrupt on the idle CPU according to the active CPU bitmap 12-3 and invokes the hardware 12-8 to execute the interrupt. The Turbo Boost maximum frequency control module 12-7 invokes the CPU frequency scaling subsystem 12-4, which drives the hardware 12-8 using the driver 12-42 of the CPU frequency scaling subsystem, to control the maximum frequency during Turbo Boost.

The elasticity policy module calculates the total CPU load (referred to as total load) based on the PELT algorithm and then generates the active CPU bitmap. FIG. 13A is a schematic diagram of a calculation process of an active CPU bitmap according to some embodiments. Referring to FIG. 13, the elasticity policy module first performs computing power sampling 13-1 for each CPU to obtain the computing power C_{CPU} (referred to as the load information of the processor) of each CPU, and then, through computing power accumulation 13-2, it collects statistics on the total computing power Cₜₒₜₐₗ=ΣC_{CPU} (referred to as the total load) of the system. Next, the filtering 13-3 is performed on the collected total computing power, for example,

$${C}_{ma} = \frac{7}{8} {C}_{ma} + \frac{1}{8} {C}_{total}$$

(where Cₘₐ, on the left of the equation, is referred to as the filtered load, and Cₘₐ, on the right of the equation, is referred to as the historical load, for example, filtering is performed using a historical moment Cₘₐ to obtain new Cₘₐ). Then, the target computing power Cₜ=Cₘₐ+Cᵣₑₛₑᵣᵥₑ+|δC| is calculated, where Cᵣₑₛₑᵣᵥₑ is obtained from the computing power of Cₘₐ being reserved for one time (referred to as the reserved computing power), it may be considered that the CPU utilization is 50%; δC represents the fluctuation, and the arithmetic mean of Cₜₒₜₐₗ−Cₘₐ may be selected (|δC| is referred to as the fluctuating computing power). Next, the target number of cores N₁=roundup{Cₜ/C} is determined based on the target computing power (N₁ is referred to as the first number of processors, and C represents the maximum computing power of each core, also known as the rated computing power, which is read from the core). This involves core scaling 13-4, meaning that when the target computing power is high, more cores are activated, and when the target computing power is low, more cores are put to the idle state. Finally, the maximum queuing capability (referred to as the task queuing capability) of each core may be considered, to define the target number of cores N₂=roundup{Tₜₒₜₐₗ/2} (N₂ is referred to as the second number of processors, Tₜₒₜₐₗ indicates the total number of queued processes, also known as the number of tasks, and 2 represents the task queuing capability.) The final total number of active cores (referred to as the number M of active processors) is set to max{N₁, N₂}. Finally, according to the calculated total number of active cores, the CPU with the maximum load in the system is selected to generate the active CPU bitmap 13-5.

FIG. 13B is a schematic diagram of a process for selecting a CPU according to some embodiments. The server 13-6 has 10 CPUs, each with a 10% load. According to the loads 13-7 of all CPUs and the CPU utilization, it is initially determined that two CPUs are selected as active CPUs. Then, considering the impact of the computing power fluctuation 13-8, the number of active CPUs is increased to 3. Finally, considering the impact of the number of tasks 13-9 that each CPU can process in the queue, the number of active CPUs is further increased to 5, to obtain the active CPU bitmap. Finally, based on the active CPU bitmap, these tasks are allocated to the 5 active CPUs for processing, and the sleep level of the idle CPUs is adjusted to C6, with the frequency set to minimum.

Using the active CPU bitmap, task scheduling may only be assigned to the active CPU.

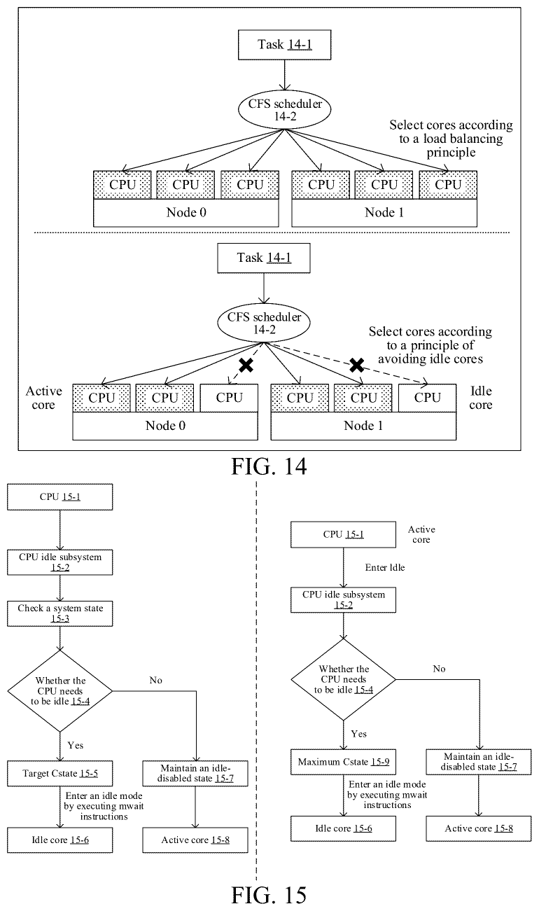

Exemplarily, FIG. 14 is a schematic comparison diagram of task scheduling based on load balancing and task scheduling based on an active CPU bitmap according to some embodiments. When task scheduling is performed based on load balancing, the CFS 14-2 may select cores for the task 14-1 according to the load balancing principle, so that each CPU may be selected (Node 0 and Node 1 in the drawing are nodes formed by encapsulating three CPUs). However, when task scheduling is performed based on the active CPU bitmap (which is the task scheduling method in some embodiments), the CFS 14-2 selects cores for the task 14-1 according to the principle of avoiding idle cores (referred to as idle processors). In other words, when a CPU is an idle core, the CFS 14-2 will only select from active cores.

The CPU idle subsystem is configured to limit the maximum depth during sleep of an active core (referred to as an active processor) to C1 to ensure performance, and to limit the sleep of an idle core to the maximum depth. FIG. 15 is a comparison diagram of limiting a sleep depth of an idle core according to some embodiments. Referring to FIG. 15, in the related technology, the CPU idle subsystem 15-2 is scheduled for the CPU 15-1. The CPU idle subsystem 15-2 checks the system state 15-3 and determines whether the CPU may be idle 15-4. If yes, a target Cstate is set for the CPU 15-5. The CPU enters the idle mode by executing the mwait instructions, becoming an idle core 15-6. If no, an idle-disabled state is maintained for the CPU 15-7, keeping it as an active core 15-8. In the solution of some embodiments, the process of checking the system state 15-3 is omitted, and whether the CPU may be idle is determined 15-4. If yes, a maximum Cstate (referred to as the maximum sleep depth) is set for the CPU 15-9. The CPU then enters the idle mode by executing the mwait instructions, becoming an idle core 15-6. If no, an idle-disabled state is maintained for the CPU 15-7, keeping it as an active core 15-8.

The CPU frequency scaling subsystem is configured to adjust the CPU frequency of the active core to the maximum frequency and adjust the CPU frequency of the idle core to the minimum frequency. Some embodiments process thereof is similar to the process of FIG. 15.

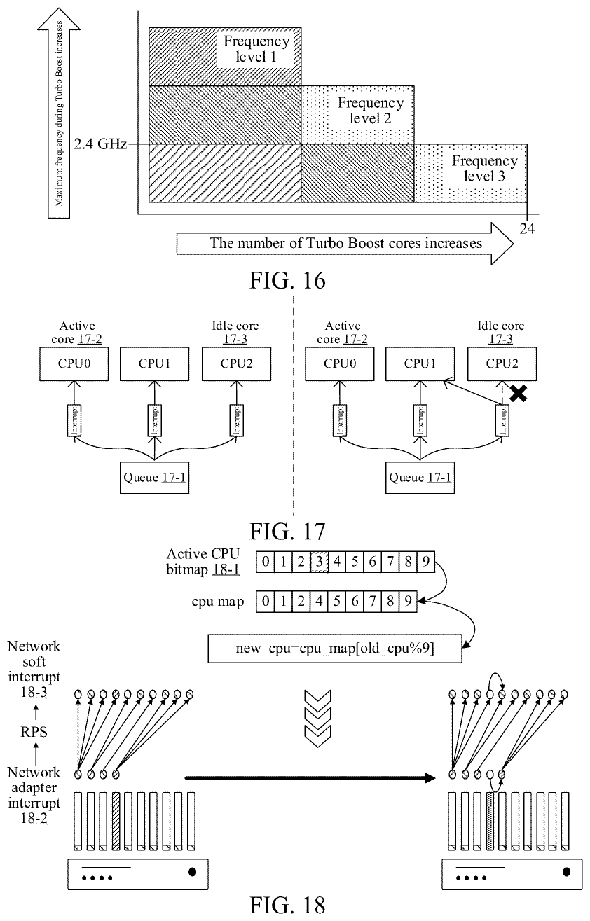

The Turbo Boost maximum frequency control module controls the maximum frequency of the CPU during Turbo Boost using a parameter (referred to as the maximum frequency parameter). Exemplarily, FIG. 16 is a schematic diagram of a variation of a maximum frequency during Turbo Boost according to some embodiments. Referring to FIG. 16, as the number of Turbo Boost cores increases, the maximum frequency during Turbo Boost gradually decreases, for example, from frequency level 1 to frequency level 3. For example, when the number of Turbo Boost cores reaches 24, the maximum frequency decreases to frequency level 3, which is 2.4 GHz. Conversely, when the number of Turbo Boost cores decreases, the maximum frequency during Turbo Boost increases. To achieve power saving, the maximum frequency during Turbo Boost may be controlled.

The interrupt migration module limits an interrupt of the CPU to an active core using the active CPU bitmap. Exemplarily, FIG. 17 is a schematic comparison diagram of an interrupt constraint according to some embodiments. When interrupt constraint is performed based on the related technology, for an interrupt in queue 17-1, both the active cores 17-2 (i.e., CPU0 and CPU1) and the idle core 17-3 (CPU2) need to respond for processing. However, in the technology of some embodiments, if an interrupt in queue 17-1 is bound to an idle core, it may be migrated to an active core for processing. In this way, the idle core may remain in an idle state continuously.

FIG. 18 is a schematic diagram of an interrupt migration process according to some embodiments. When CPU3 is in an inactive state, the server system generates a discontinuous active CPU bitmap (referred to as a sparse bitmap) 18-1, then rearranges the bitmap to form an array, cpu_map (referred to as the bitmap array), with the specific content being {0, 1,2,4,5,6,7,8,9}. Then, the server system performs remainder indexing on cpu_map using the originally specified CPU (referred to as the processor identifier of an idle processor), for example, it performs the processing new_cpu=cpu_map[old_cpu%9] to obtain the remapped CPU (referred to as the mapped processor). For example, the interrupt affinity of the original CPU3 is re-affinized to CPU4 according to cpu_map[3]=4. Referring to FIG. 18, for a network adapter interrupt 18-2, the server system affinitizes it to CPU4. For an idle core selected by request per second (RPS), the server system also re-affinitizes the corresponding data packet to another CPU, such as CPU4, for processing, to perform a network soft interrupt 18-3.

Interrupt affinity refers to binding an interrupt to a specified CPU. Once the binding is completed, the interrupt will only occur on the bound CPU. Through this function, different interrupts may be distributed across different CPUs to balance the utilization of each CPU, preventing excessive overhead on a single CPU caused by interrupts being too concentrated.

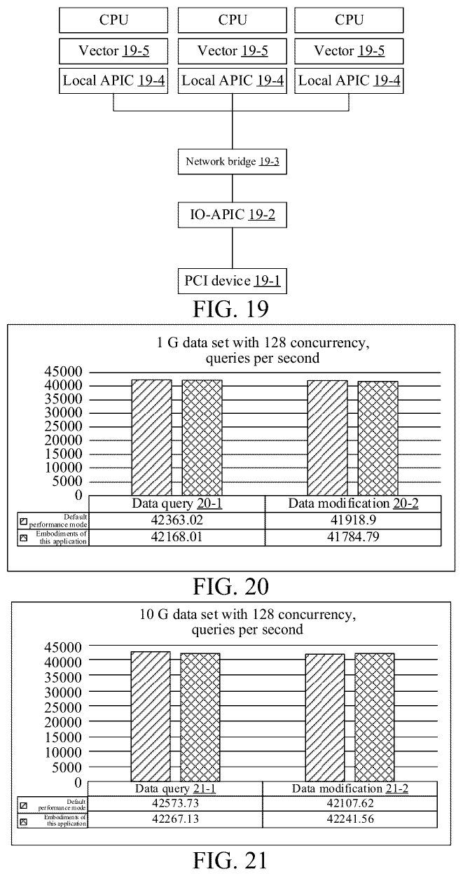

Referring to FIG. 19, FIG. 19 is a schematic diagram of an interrupt processing procedure according to some embodiments. A peripheral component interconnect (PCI) device 19-1 (a device in the PCI slot) transfers the interrupt CPU, interrupt vector, and interrupt method to the input/output advanced programmable interrupt controller (IO-APIC) 19-2 using message signaled interrupt (MSI) information. After receiving the MSI information, the IO-APIC 19-2 forwards it to the target CPU's local APIC 19-4 through the Bridge 19-3. Once the local APIC receives the MSI information, it triggers the interrupt corresponding to the vector 19-5, thus initiating the interrupt processing procedure. Herein, a device external interrupt number virq is a logical number. Each CPU independently maintains its own interrupt vector table, and the mapping from virq to a vector is maintained by the system.

The essence of interrupt affinity is implemented through the Message Address register and the Message Data register of the PCI device. The Message Address register records the ID of the target CPU to be interrupted, while the Message Data register records the interrupt vector number, interrupt triggering method, and other related information. Attention may be paid to the distinction between a virq and an interrupt vector number. Additionally, if a virq is bound to a plurality of CPUs, the system may automatically select the optimal CPU to process the interrupt based on the IRQ load. When sending an interrupt, the PCI device essentially transmits the values of the Message Address register and the Message Data register to the IO-APIC. Interrupt migration in some embodiments essentially involves modifying interrupt affinity.

Below is a comparative description of the server's performance and power consumption after applying the method according to some embodiments and applying the default performance mode (for example, with all CPUs in performance mode).

When a server performs database operations, the method according to some embodiments and the method in the related technology are applied separately for testing. The test content may include performing stress tests for addition, deletion, and search operations on a 1 G data set, a 10 G data set, and a 100 G data set, with concurrency levels of 128, 256, and 512, respectively.

Exemplarily, FIG. 20 is a schematic comparison diagram of queries per second at 128 concurrency for a 1 G data set according to some embodiments. Referring to FIG. 20, for data query 20-1, the queries per second in the default performance mode is 42363.02, while the queries per second in some embodiments is 42168.01. For data modification 20-2, the queries per second in the default performance mode is 41918.9, while the queries per second in some embodiments is 41784.79.

FIG. 21 is a schematic comparison diagram of queries per second at 128concurrency for a 10 G data set according to some embodiments. Referring to FIG. 21, for data query 21-1, the queries per second in the default performance mode is 42573.73, while the queries per second in some embodiments is 42267.13. For data modification 21-2, the queries per second in the default performance mode is 42107.62, while the queries per second in some embodiments is 42241.56.

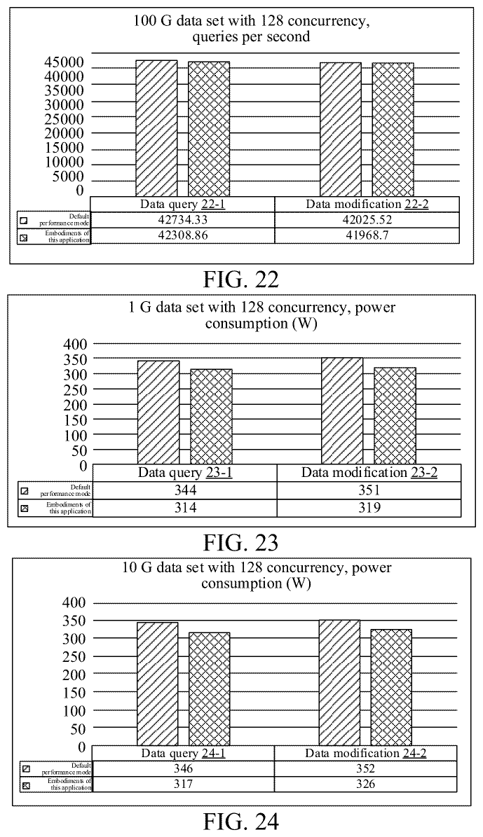

FIG. 22 is a schematic comparison diagram of queries per second at 128 concurrency for a 100 G data set according to some embodiments. Referring to FIG. 22, for data query 22-1, the queries per second in the default performance mode is 42734.33, while the queries per second in some embodiments is 42308.86. For data modification 22-2, the queries per second in the default performance mode is 42025.52, while the queries per second in some embodiments is 41968.7.

As shown in FIG. 20 to FIG. 22, whether in a 1 G data set, a 10 G data set, or a 100 G data set, the queries per second for data queries and data modifications in some embodiments is essentially the same as in the default performance mode, indicating that some embodiments can ensure the server's performance compared to the default performance mode.

FIG. 23 is a schematic comparison diagram of power consumption at 128concurrency for a 1 G data set according to some embodiments. For data query 23-1, the power consumption in the default performance mode is 344, while the power consumption in some embodiments is 314. For data modification 23-2, the power consumption in the default performance mode is 351, while the power consumption in some embodiments is 319. The unit of power consumption is watts.

FIG. 24 is a schematic comparison diagram of power consumption at 128 concurrency for a 10 G data set according to some embodiments. For data query 24-1, the power consumption in the default performance mode is 346, while the power consumption in some embodiments is 317. For data modification 24-2, the power consumption in the default performance mode is 352, while the power consumption in some embodiments is 326 (The unit of power consumption is watts).

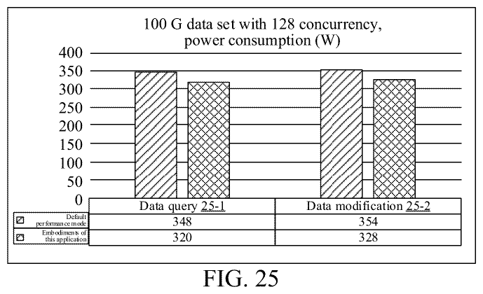

FIG. 25 is a schematic comparison diagram of power consumption at 128 concurrency for a 100 G data set according to some embodiments. For data query 25-1, the power consumption in the default performance mode is 348, while the power consumption in some embodiments is 320. For data modification 25-2, the power consumption in the default performance mode is 354, while the power consumption in some embodiments is 328 (The unit of power consumption is watts).

As shown in FIG. 23 to FIG. 25, whether in a 1 G data set, a 10 G data set, or a 100 G data set, the power consumption in some embodiments is lower than in the default performance mode. Therefore, the CPU scheduling method according to some embodiments can not only ensure the performance of the server, but also achieve power saving for the server.

In some embodiments, user information, such as data related to to-be-processed tasks, is involved. When some embodiments are applied to specific products or technologies, user permission or consent is required, and the collection, use, and processing of relevant data need to comply with the applicable laws, regulations, and standards of relevant countries and regions.

The following further describes an exemplary structure in which the processor scheduling apparatus 255 according to some embodiments is implemented as a software module. In some embodiments, as shown in FIG. 8, the software module, included in the processor scheduling apparatus 255 stored in the memory 250, may include: a load acquisition module 2551, configured to acquire a total load of N processors, where N≥2; a bitmap generation module 2552, configured to generate, based on the total load, a processor bitmap of the N processors, where the processor bitmap is configured to distinguish an active processor and an idle processor in the N processors; and a processor control module 2553, configured to process, based on the processor bitmap, a to-be-processed task on the active processor, and adjust the idle processor to a target power-saving mode.

In some embodiments, the bitmap generation module 2552 is further configured to: perform filter processing on the total load to obtain a filtered load; determine, based on the filtered load, target computing power corresponding to the total load; determine, based on the target computing power and rated computing power of each processor, M active processors and N-M idle processors in the N processors, 1≤M<N; and generate an initial bitmap of the N processors; mark, using a first mark, processor identifiers of the M active processors in the initial bitmap, and mark, using a second mark, processor identifiers of the N-M idle processors in the initial bitmap, to obtain the processor bitmap.

In some embodiments, the bitmap generation module 2552 is further configured to: acquire a historical load, and perform weighted fusion on the historical load and the total load, to obtain the filtered load, a weighted weight of the historical load being greater than a weighted weight of the total load.

In some embodiments, the bitmap generation module 2552 is further configured to: determine matching computing power and reserved computing power corresponding to the filtered load, where the reserved computing power is computing power that the processor may have in addition to computing power for processing the filtered load; superimpose the matching computing power and the reserved computing power to obtain first superimposed computing power; and add fluctuating computing power corresponding to load fluctuation to the first superimposed computing power to obtain second superimposed computing power, and determine the second superimposed computing power as the target computing power corresponding to the total load.

In some embodiments, the bitmap generation module 2552 is further configured to: determine, according to the target computing power and the rated computing power of each processor, the first number of processors to achieve the target computing power; determine, according to the number of tasks corresponding to the total load and a task queuing capability of each processor, the second number of processors to complete the number of tasks; determine the greater of the first number of processors and the second number of processors as the number M of the active processors; and determine M processors with a maximum load in the N processors as the active processors, and determine N-M processors different from the active processors in the N processors as the idle processors.

In some embodiments, the bitmap generation module 2552 is further configured to: perform load sampling on each processor to obtain load information of each processor; and accumulate N pieces of load information corresponding to the N processors to obtain the total load of the N processors.

In some embodiments, the active processor operates in one of a maximum performance mode and a specified performance mode, where: a processor frequency of the maximum performance mode is a maximum frequency, and a sleep depth is a minimum depth; and a processor frequency of the specified performance mode is a specified frequency, and a sleep depth is a minimum depth; and a processor frequency of the target power-saving mode is a minimum frequency, and a sleep depth is one of a maximum depth and a specified depth.

In some embodiments, the processor scheduling apparatus 255 further includes: an interrupt migration module 2554, configured to determine, based on the processor bitmap, a mapped processor of the idle processor from the active processors, and process an interrupt on the idle processor through the mapped processor.

In some embodiments, the interrupt migration module 2554 is further configured to: delete a processor identifier of the idle processor from the processor bitmap to obtain a sparse bitmap; determine a remainder obtained by dividing the processor identifier of the idle processor by a length of a bitmap array, where the bitmap array is an array obtained by closely arranging the sparse bitmap; and determine, in the bitmap array, a target identifier corresponding to the remainder, and determine an active processor corresponding to the target identifier as the mapped processor.

In some embodiments, the interrupt migration module 2554 is further configured to: process a network adapter interrupt on the idle processor through the mapped processor to obtain a data packet of the network adapter interrupt; distribute the data packet to the N processors; and migrate, when the data packet is distributed to the idle processor, the data packet to the mapped processor, and perform soft interrupt processing on the data packet through the mapped processor.

In some embodiments, the processor scheduling apparatus 255 further includes: a frequency setting module 2555, configured to set, using a maximum frequency parameter, a maximum frequency of the active processor during Turbo Boost.

In some embodiments, the bitmap generation module 2552 is further configured to: determine a difference in total load between the total load of the N processors and a total historical load corresponding to each of a plurality of historical bitmaps; and determine a historical bitmap corresponding to a total historical load, where the difference in total load is less than a difference threshold, as the processor bitmap of the N processors.

Some embodiments provide a computer program product. The computer program product includes a computer program or computer-executable instructions. The computer program or the computer-executable instructions is or are stored in a computer-readable storage medium. A processor of a computer device reads the computer-executable instructions from the computer-readable storage medium and executes the computer-executable instructions, causing the computer device to perform the processor scheduling method according to some embodiments.

Some embodiments provide a computer-readable storage medium having computer-executable instructions stored therein. When the computer-executable instructions are executed by a processor, the processor is enabled to perform the processor scheduling method according to some embodiments, for example, the processor scheduling method shown in FIG. 9.

In some embodiments, the computer-readable storage medium may be a memory such as ferroelectric RAM (FRAM), ROM, programmable ROM (PROM), erasable programmable ROM (EPROM), electrically erasable programmable ROM (EEPROM), flash memory, magnetic surface memory, optical disk, or compact disc (CD-ROM). It may be a device that includes one or any combination of the above memory types.

In some embodiments, the computer-executable instructions may be written in the form of a program, software, software module, script, or code in any programming language (including compiled or interpreted languages, as well as declarative or procedural languages). The instructions may be deployed in various forms, including as an independent program, or as a module, component, subroutine, or other unit suitable for use in a computing environment.

In an example, the computer-executable instructions may, but do not necessarily, correspond to a file in a file system, and may be stored in a part of a file that saves other programs or other data, for example, be stored in one or more scripts in a hyper text markup language (HTML) file, stored in a file that is specially configured for a discussion program, or stored in a plurality of collaborative files (for example, be stored in files of one or more modules, subprograms, or code parts).

In an example, the computer-executable instructions may be deployed to be executed on a computer device, or deployed to be executed on a plurality of computer devices at the same location, or deployed to be executed on a plurality of computer devices that are distributed in a plurality of locations and interconnected using a communication network.

In conclusion, according to some embodiments, the computer device generates a processor bitmap based on the total load of the N processors, which is configured to distinguish an active processor and an idle processor in the N processors. Then, using the global load as a granularity, the computer device divides the N processors into active processors and idle processors based on the processor bitmap of the N processors. This allows: (1) A to-be-processed task is processed on the active processor, thereby enabling a quick response to the to-be-processed task and ensuring the processing performance of the computer device; (2) The idle processor is adjusted to the target power-saving mode, allowing the idle processor to operate in a low-power state, thereby achieving power saving for the computer device; (3) The computer device directly adjusts the idle processor to the target power-saving mode, reducing the time needed to balance performance and power consumption, thereby reducing the time for the computer device to achieve power saving. (4) The computer device determines a corresponding mapped processor for an idle processor and re-affinizes the interrupt bound to the idle processor to the corresponding mapped processor for processing, ensuring that the interrupt originally bound to the idle processor is correctly responded to, thereby guaranteeing a high success rate of interrupt execution.

According to some embodiments, each module or unit may exist respectively or be combined into one or more units. Some units may be further split into multiple smaller function subunits, thereby implementing the same operations without affecting the technical effects of some embodiments. The units are divided based on logical functions. Practically, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A processor scheduling method, performed by a computer device, the method comprising:
acquiring a total load of N processors, N being a first positive integer greater than or equal to 2;
generating, based on the total load, a processor bitmap distinguishing at least one active processor and at least one idle processor among the N processors;
processing, based on the processor bitmap, a to-be-processed task on the at least one active processor; and
adjusting, based on the processor bitmap, the at least one idle processor to a target power-saving mode.

2. The method according to claim 1, wherein the generating, based on the total load, a processor bitmap comprises:
performing filter processing on the total load and obtaining a filtered load;
determining, based on the filtered load, a target computing power corresponding to the total load;
determining, based on the target computing power and a rated computing power of each processor, M active processors and N-M idle processors among the N processors, M being a second positive integer less than or equal to N;
generating an initial bitmap of the N processors;
marking, with a first mark, processor identifiers of the M active processors in the initial bitmap;
marking, with a second mark, processor identifiers of the N-M idle processors in the initial bitmap; and
obtaining the processor bitmap.

3. The method according to claim 2, wherein the performing filter processing on the total load comprises:
acquiring a historical load of the N processors;
performing weighted fusion on the historical load and the total load;
obtaining the filtered load, wherein
a weighted weight of the historical load is greater than a weighted weight of the total load.

4. The method according to claim 2, wherein the determining, based on the filtered load, a target computing power corresponding to the total load comprises:
determining matching computing power and reserved computing power that are corresponding to the filtered load,
wherein the reserved computing power is computing power that the processor may have in addition to computing power for processing the filtered load;
superimposing the matching computing power and the reserved computing power and obtaining first superimposed computing power;
adding fluctuating computing power corresponding to load fluctuation to the first superimposed computing power and obtaining second superimposed computing power; and
determining the second superimposed computing power as the target computing power corresponding to the total load.

5. The method according to claim 2, wherein the determining, based on the target computing power and a rated computing power of each processor, M active processors and N-M idle processors among the N processors comprises:
determining, based on the target computing power and the rated computing power of each processor, a first number of processors associated with the target computing power;
determining, based on a number of tasks corresponding to the total load and a task queuing capability of each processor, a second number of processors associated with completing the number of tasks;
determining a greater of the first number of processors and the second number of processors as M; and
determining M processors with a maximum load among the N processors as the active processors, and determining N-M processors that are different from the active processors among the N processors as the idle processors.

6. The method according to claim 1, wherein the acquiring a total load of N processors comprises:
performing load sampling on each processor and obtaining load information of each processor; and
accumulating N pieces of load information corresponding to the N processors and obtaining the total load of the N processors.

7. The method according to claim 1,
wherein the at least one active processor operates in at least one of a maximum performance mode or a specified performance mode,
wherein a processor frequency of the maximum performance mode is a maximum frequency and a sleep depth is a minimum depth,
wherein a processor frequency of the specified performance mode is a specified frequency and a sleep depth is a minimum depth, and
wherein a processor frequency of the target power-saving mode is a minimum frequency and a sleep depth is at least one of a maximum depth or a specified depth.

8. The method according to claim 1, wherein after the generating, based on the total load, a processor bitmap, the method further comprising:
determining, based on the processor bitmap, a mapped processor of the at least one idle processor from the active processors; and
processing an interrupt on the at least one idle processor through the mapped processor.

9. The method according to claim 8, wherein the determining, based on the processor bitmap, a mapped processor of the at least one idle processor from the active processors comprises:
deleting a processor identifier of the at least one idle processor from the processor bitmap and obtaining a sparse bitmap;
determining a remainder by dividing the processor identifier of the at least one idle processor by a length of a bitmap array, wherein the bitmap array is an array based on closely arranging the sparse bitmap; and
determining, in the bitmap array, a target identifier corresponding to the remainder, and determining an active processor corresponding to the target identifier as the mapped processor.

10. The method according to claim 8, wherein the processing an interrupt on the at least one idle processor through the mapped processor comprises:
processing a network adapter interrupt on the at least one idle processor through the mapped processor and obtaining a data packet of the network adapter interrupt;
distributing the data packet to the N processors;
migrating, based on the data packet being distributed to the at least one idle processor, the data packet to the mapped processor; and
performing soft interrupt processing on the data packet through the mapped processor.

11. The method according to claim 1, the method further comprising:
setting, based on a maximum frequency parameter, a maximum frequency of the at least one active processor during Turbo Boost.

12. The method according to claim 1, wherein the generating, based on the total load, a processor bitmap comprises:
determining, for each of a plurality of historical bitmaps, a load difference between the total load of the N processors and a corresponding total historical load; and
determining, as the processor bitmap, a historical bitmap corresponding to a total historical load, where the load difference is less than a difference threshold.

13. A processor scheduling apparatus, comprising:
at least one memory configured to store computer program code; and
at least one processor configured to read the program code and operate as instructed by the program code, the program code comprising:
acquiring code configured to cause at least one of the at least one processor to acquire a total load of N processors, N being a first positive integer greater than or equal to 2;
generating code configured to cause at least one of the at least one processor to generate, based on the total load, a processor bitmap distinguishing at least one active processor and at least one idle processor among the N processors;
processing code configured to cause at least one of the at least one processor to process, based on the processor bitmap, a to-be-processed task on the at least one active processor; and
adjusting code configured to cause at least one of the at least one processor to adjust, based on the processor bitmap, the at least one idle processor to a target power-saving mode.

14. The apparatus according to claim 13, wherein the generating code is further configured to cause at least one of the at least one processor to:
perform filter processing on the total load and obtain a filtered load;
determine, based on the filtered load, a target computing power corresponding to the total load;
determine, based on the target computing power and a rated computing power of each processor, M active processors and N-M idle processors among the N processors, M being a second positive integer less than or equal to N;
generate an initial bitmap of the N processors;
mark, with a first mark, processor identifiers of the M active processors in the initial bitmap;
mark, with a second mark, processor identifiers of the N-M idle processors in the initial bitmap; and
obtain the processor bitmap.

15. The apparatus according to claim 14, wherein the generating code is further configured to cause at least one of the at least one processor to:
acquire a historical load of the N processors;
perform weighted fusion on the historical load and the total load;
obtain the filtered load, wherein
a weighted weight of the historical load is greater than a weighted weight of the total load.

16. The apparatus according to claim 14, wherein the generating code is further configured to cause at least one of the at least one processor to:
determine matching computing power and reserved computing power that are corresponding to the filtered load, wherein the reserved computing power is computing power that the processor may have in addition to computing power for processing the filtered load;
superimpose the matching computing power and the reserved computing power and obtain first superimposed computing power;
add fluctuating computing power corresponding to load fluctuation to the first superimposed computing power and obtain second superimposed computing power; and
determine the second superimposed computing power as the target computing power corresponding to the total load.

17. The apparatus according to claim 14, wherein the generating code is further configured to cause at least one of the at least one processor to:
determine, based on the target computing power and the rated computing power of each processor, a first number of processors associated with the target computing power;
determine, based on a number of tasks corresponding to the total load and a task queuing capability of each processor, a second number of processors associated with completing the number of tasks;
determine a greater of the first number of processors and the second number of processors as M; and
determine M processors with a maximum load among the N processors as the active processors, and determine N-M processors that are different from the active processors among the N processors as the idle processors.

18. The apparatus according to claim 13, wherein the acquiring code is further configured to cause at least one of the at least one processor to:
perform load sampling on each processor and obtain load information of each processor; and
accumulate N pieces of load information corresponding to the N processors and obtain the total load of the N processors.

19. The method according to claim 13,
wherein the at least one active processor operates in at least one of a maximum performance mode or a specified performance mode,
wherein a processor frequency of the maximum performance mode is a maximum frequency and a sleep depth is a minimum depth,
wherein a processor frequency of the specified performance mode is a specified frequency and a sleep depth is a minimum depth, and
wherein a processor frequency of the target power-saving mode is a minimum frequency and a sleep depth is at least one of a maximum depth or a specified depth.

20. A non-transitory computer-readable storage medium, storing computer code which, when executed by at least one processor, causes the at least one processor to at least:
acquire a total load of N processors, N being a first positive integer greater than or equal to 2;
generate, based on the total load, a processor bitmap distinguishing at least one active processor and at least one idle processor among the N processors;
process, based on the processor bitmap, a to-be-processed task on the at least one active processor; and
adjust, based on the processor bitmap, the at least one idle processor to a target power-saving mode.
